(19) United States
(12) Patent Application Publication
(10) Pub. No.: US 2015/0092124 A1
(43) Pub. Date: Apr. 2, 2015

(54) EYEGLASSES APPARATUS

(71) Applicant: Kabushiki Kaisha Toshiba, Tokyo (JP)

(72) Inventor: Hideaki Haruyama, Fujisawa-shi (JP)

(21) Appl. No.: 14/454,567

(22) Filed: Aug. 7, 2014

Related U.S. Application Data
(60) Provisional application No. 61/883,886, filed on Sep. 27, 2013.

(51) Int. Cl. G02F 1/133; G02C 7/02

(52) U.S. Cl. CPC G02F 1/13306; G02C 7/02
USPC 349/13

(57) ABSTRACT

According to one embodiment, an apparatus includes first and second liquid crystal lenses, a pair of temples, a sensor, and a driver. The first liquid crystal lens includes a first liquid crystal layer and a plurality of first control electrodes on the first liquid crystal layer. The sensor is provided on one of the pair of temples, and detects a contact position on a detector plane. The driver applies a plurality of voltage to the plurality of the first control electrodes. A focal length of the first liquid crystal lens is determined according to an amount of movement of the contact position when the contact position continuously moves along a longitudinal direction of the sensor. Each voltage value is determined according to the focal length of the first liquid crystal lens.

### CROSS-REFERENCE TO RELATED APPLICATIONS

This application claims the benefit of U.S. Provisional Application No. 61/883,886, filed Sep. 27, 2013, the entire contents of which are incorporated herein by reference.

### FIELD

Embodiments described herein relate generally to a pair of eyeglasses apparatus comprising liquid crystal lenses.

### BACKGROUND

With aging, the power of accommodation of the intraocular lens (crystalline lens) declines and it becomes difficult for people to focus on both near and far objects with the naked eye or with eyeglasses having unifocal lenses. The number of such people is estimated to be about 12 million. In addition, the number of people suffering from visual problems caused by cataracts due to aging is increasing. In Japan, approximately 10 million people suffer from cataracts so severe as to require surgery. While the surgery itself is relatively straightforward and inexpensive, the post-operative ability of the lens to accommodate is completely lost. To counter this side effect, several pairs of eyeglasses are required according to how near or far an object to be viewed is. In another case, a single pair of eyeglasses with multifocal or varifocal lenses is utilized although it is inevitable that the field of view appropriate for near objects or for distant objects is limited.

In recent years, in place of such materials as glass and resin, a lens using liquid crystal has been developed. The liquid crystal lens is capable of changing its refractive index by changing a voltage applied to the liquid crystal.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view of an appearance of a pair of eyeglasses according to an embodiment.

FIG. 2 illustrates an example of use of a pair of eyeglasses.

FIG. 3 is an exemplary view of a lens structure.

FIG. 4 is an exemplary section view of a liquid crystal lens.

FIG. 5 illustrates an example structure of a control electrode in a liquid crystal lens.

FIG. 6 is an exemplary block diagram of a configuration to drive a liquid crystal lens.

FIG. 7 illustrates an example structure of a lens.

FIG. 8 is an exemplary section view of a structure of first and second liquid crystal lenses provided on a lens shown in FIG. 7.

FIG. 9 is an exemplary block diagram of a configuration to drive a liquid crystal lens.

### DETAILED DESCRIPTION

Various embodiments will be described hereinafter with reference to the accompanying drawings.

In general, according to one embodiment, an eyeglasses apparatus includes first and second liquid crystal lenses, first and second liquid crystal lenses, a sensor, and a driver. The first liquid crystal lens includes a first liquid crystal layer and a plurality of first control electrodes on the first liquid crystal layer. The sensor is provided on one of the pair of temples, includes a longitudinal direction, and detects a contact position on a detector plane. The driver applies a plurality of voltage to the plurality of the first control electrodes. A focal length of the first liquid crystal lens is determined according to an amount of movement of the contact position when the contact position continuously moves along the longitudinal direction, and each voltage value is determined according to the focal length of the first liquid crystal lens.

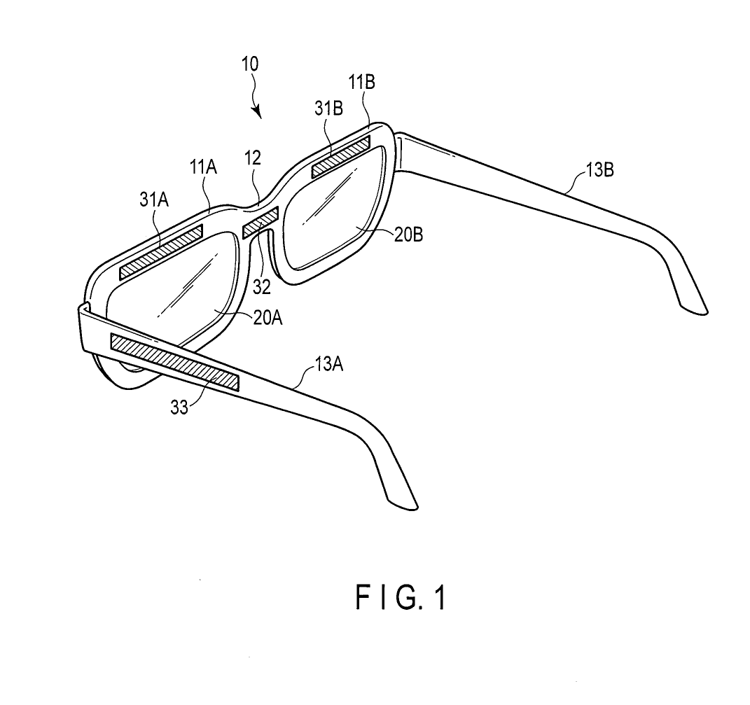

FIG. 1 illustrates the appearance of a pair of eyeglasses (eyeglasses apparatus) 10.

The pair of eyeglasses comprises limbs 11A and 11B, a bridge 12, temples 13A and 13B, and the like. To the pair of limbs 11A and 11B, lenses 20A and 20B are fixed. In an upper part of the pair of limbs 11A and 11B, a driver 31 to be described later is embedded. Inside the bridge 12, a controller 32 and a battery (not shown in the figure) are embedded. In one of the pairs of temples 13A and 13B, namely in the temple 13A, a touch sensor 33 is provided.

The touch sensor provided in one temple of the pair of temples has a longitudinal direction and is configured to detect a contact position on a detector plane.

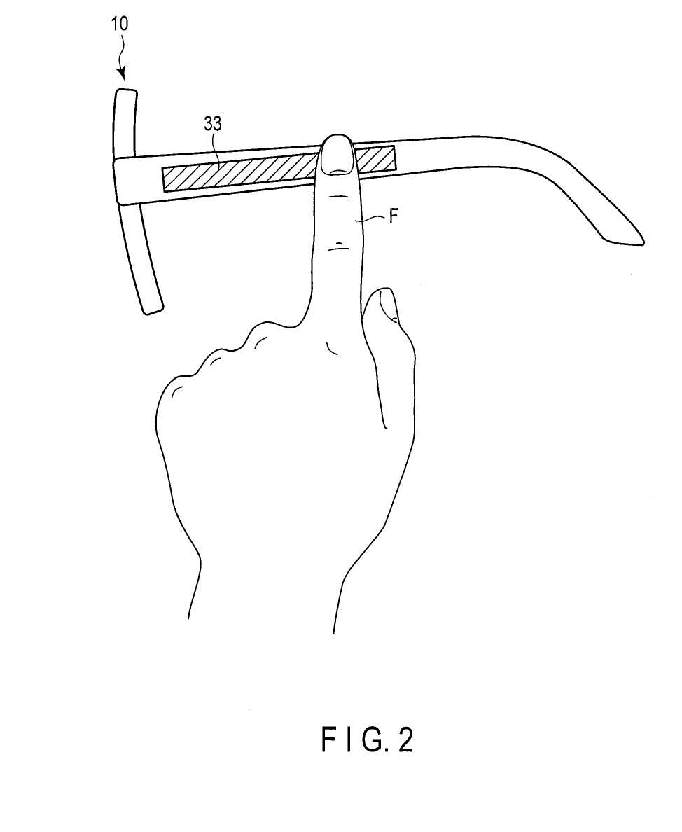

A liquid crystal lens is incorporated in the lenses 20 A and 20B. As shown in FIG. 2, the focal length of the liquid crystal lens can be changed by sliding a figure F while touching on the touch sensor 33.

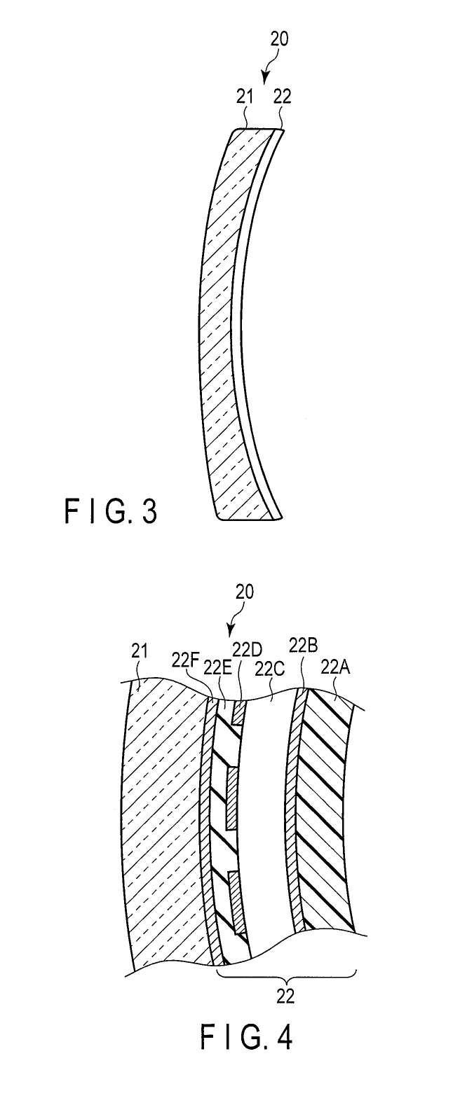

FIG. 3 illustrates a structure of the lens 20 (20A, 20B). The lens 20 includes a fixed (focus) lens 21 and a liquid crystal lens 22. The fixed focus lens 21 is a lens whose focal point is fixed. Note that the fixed focus lens 21 includes a unifocal point, a superimposed focal point or a varifocal point. The liquid crystal lens 22 is provided on a surface of the fixed lens 21. The liquid crystal lens 22 is capable of changing its focal length.

Note that the fixed focus lens 21 is depicted as a concave lens, but it can be a convex lens or a transparent plain material as well. This fixed focus lens 21 is for a rough focal adjustment based on the shape and the like of the eyeball or the cornea of a user. The liquid crystal lens 22 is for a detailed focal adjustment.

FIG. 4 is an exemplary section view of the liquid crystal lens 22.

A ground electrode 22B is provided on a protection layer 22A. On the ground electrode 22B, a liquid crystal layer 22C is provided. A plurality of control electrodes 22D are provided on the liquid crystal layer 22C. An insulation layer 22 E is provided to cover the control electrode 22D on the liquid crystal layer 22C. On the insulation layer 22E, a wiring layer 22F is provided. The ground electrode 22B, the control electrode 22D and the wiring layer 22F are formed of a transparent electrode material such as indium tin oxide (ITO) or the like.

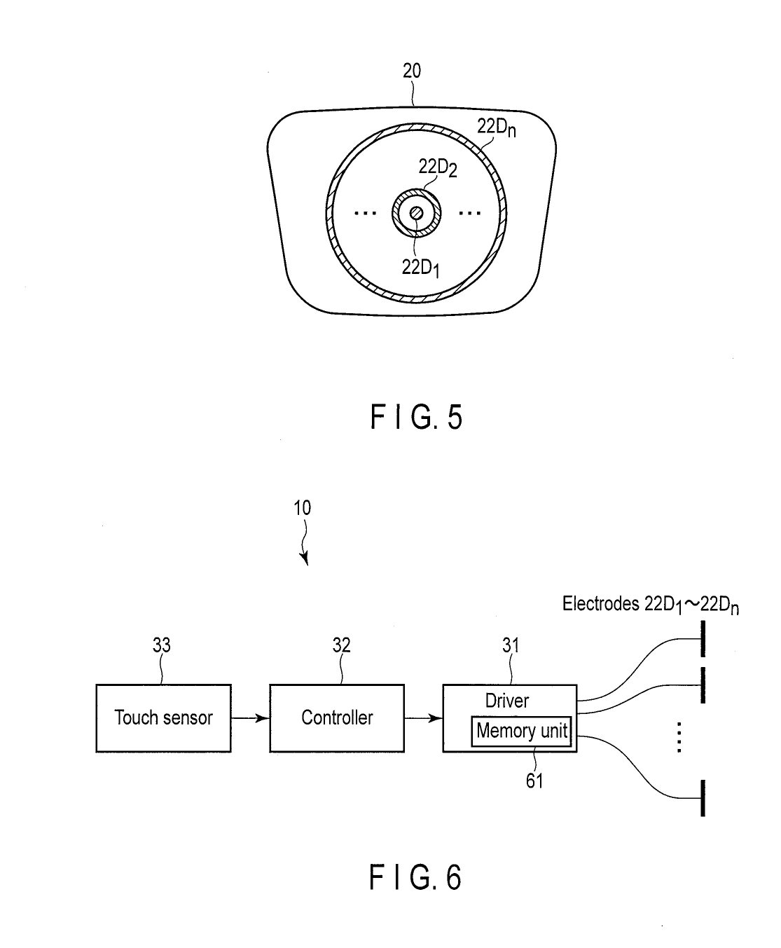

FIG. 5 illustrates a structure of a control electrode in a liquid crystal lens. As shown in FIG. 5, a plurality of control electrodes 22D₁, 22D₂, . . . , 22Dₙ are provided concentrically. By applying voltage to each control electrode, a reflective index of a liquid crystal layer is changed. By controlling the voltage applied to each control electrode, a lens 20 can be adjusted to a lens type of either a concave lens or a convex lens to be taken and the focal length of the lens can be adjusted.

FIG. 6 is an exemplary block diagram of a configuration to adjust a liquid crystal lens to either a concave lens or a convex lens and to adjust the focal length of the lens.

A touch sensor 33 is configured to report to a controller 32 a detection signal which indicates a contact position (touch position) of a finger F. The controller 32 is configured to detect either a swipe or a tap according to the detection signal from the touch sensor 33, which indicates the touch position. If the touch position is not been changed substantially and the finger is lifted after a short time, the controller 32 is configured to determine this to be a tap. If the touch position has continuously changed in a longitudinal direction of a temple, the controller 32 determines this to be a swipe.

If a swipe is detected, the controller 32 determines the focal length of a liquid crystal lens 22 of each of the lenses 20A and 20B according to the swipe. The controller 32 is configured to determine the focal length of each liquid crystal lens according to the direction and the amount of movement of the swipe.

If the swipe is from the back toward the front (limb side), the controller 32 gradually increases the focal length of the liquid crystal lens. Note that the lens is generally configured to function as a concave lens for viewing distant objects. In this case, the controller 32 sets the lens to be stronger for viewing objects at increasing distance, that is to say, it controls the lens to reduce the focal length of the concave lens. Thus, the controller 32 is configured to gradually reduce the focal length of the liquid crystal lens if the swipe is from the front toward the back.

In the touch operation, the controller 32 determines the focal length according to the position of the touch operation. This can be used in such a case where the focal length is discretely controlled with “far,” “near,” and “magnify”.

The controller 32 is configured to report focal length information which indicates the determined focal length to a driver 31 (31A, 31B). The controller 32 may be configured to transmit the focal length information by a wireless signal or by an electrical signal to the driver 31.

The driver 31 is configured to determine a value of voltage applied to each control electrode of the liquid crystal 22 according to the reported focal length. The driver 31 comprises a memory unit 61 which stores a plurality of parameter sets wherein the lens types (concave lens or convex lens) for viewing near objects, distant objects and the like or for a magnifying glass, and each voltage value applied to each respective one of the control electrodes 22D₁, 22D₂, . . . , 22Dₙ corresponding to the focal length of the lens are written. The parameter sets correspond to several basic focal lengths. The driver 31 is also configured select an appropriate parameter set based on the reported focal length (control) information. By interpolating the parameter sets, the focal length can be controlled to an intermediate level. Controlling the focal length to the intermediate level is preferable especially for a cataract patient having an artificial crystalline lens. Note that the parameter sets may be written in a table. Also, the parameter sets may be prepared by deriving each voltage applied to each of respective one of the control electrodes 22D₁, 22D₂, . . . , 22Dₙ from more than one calculation formulas.

The memory unit 61 can also be provided in the controller 32. The controller 32 determines each voltage applied to each respective one of the control electrodes 22D₁, 22D₂, . . . , 22Dₙ based on the determined focal length. The controller 32 transfers applied voltage information which indicates each voltage applied to each respective one of the control electrodes 22D₁, 22D₂, . . . , 22Dₙ to the driver 31. The controller 32 can be configured to transfer the applied voltage information corresponding to the focal length by a wireless signal or by an electrical signal to the driver 31. The driver 31 is configured to apply each voltage determined to each respective one of control electrodes 22D₁, 22D₂, . . . , 22Dₙ.

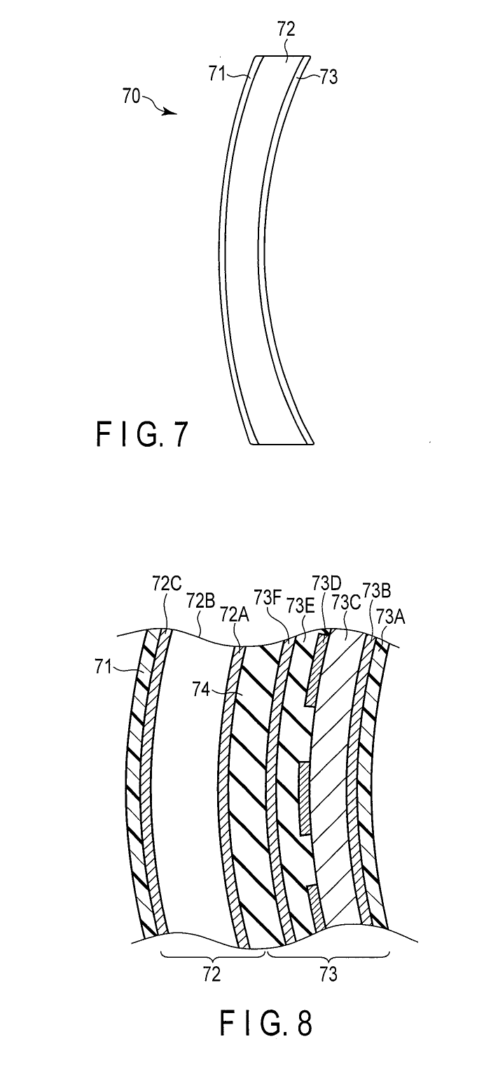

FIG. 7 illustrates a modified example of a lens structure. A lens shown in FIG. 7 comprises a protection layer 71, a first liquid crystal lens 72 and a second liquid crystal lens 73, laminated one on another.

FIG. 8 is an exemplary section view of a structure of each of the first liquid crystal lens 72 and the second liquid crystal lens 73.

The first liquid crystal lens 72 comprises an insulation layer 74, an electrode 72A, a liquid crystal layer 72B, an electrode 72C and the like. The first liquid crystal lens 72 is an alternative to a fixed focus lens. Electrodes 72A and 72C are formed of a transparent electrode material such as indium tin oxide (ITO) or the like.

Electrode 72A is provided on the insulation layer 74. On electrode 72A, the crystal liquid layer 72B is provided. Electrode 72C is provided on the crystal liquid layer 72B. The voltage applied between electrode 72A and electrode 72C is constant.

The second liquid crystal lens 73 comprises a protection layer 73A, a ground electrode 73B, a liquid crystal layer 73C, a control electrode 73D, an insulation layer 73E, a wiring layer 73F, an insulation layer 74 and the like. The ground electrode 73B, the control electrode 73D, the wiring layer 73F are formed of a transparent electrode material such as indium tin oxide (ITO) or the like.

The ground electrode 73B is provided on the protection layor 73A. On the ground electrode 73B, the liquid crystal layer 73C is provided. A plurality of control electrodes 73D are provided on the liquid crystal layer 73C. On the liquid crystal layer 73C, the insulation layer 73E is provided to cover the control electrodes 73D. The wiring layer 73F is provided on the insulation layer 73E. On the wiring layer 73F, the insulation layer 74 is provided.

Note that basically, the control electrodes are formed concentrically, but the control electrodes may be formed such that small electrodes are arranged densely to realize a fine adjustment of a planer voltage distribution.

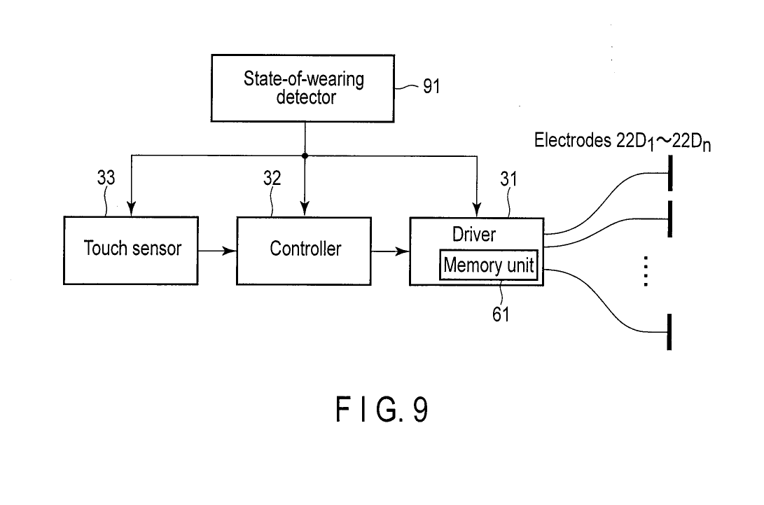

Also, as shown in FIG. 9, a state-of-wearing detector 91 may be further comprised. The state-of-wearing detector 91 is configured to detect whether a pair of eyeglasses 10 is being worn on the body. The state-of-wearing detector 91 is configured to control a circuit to be operated based on the result of the detection. In a state where the pair of eyeglasses 10 is not being worn on the body, only the state-of-wearing detector 91 is operated to minimize power consumption. The state-of-wearing detector 91 detects whether the pair of eyeglasses 10 is being worn on the body or not by detecting resistance, impedance or the like between right and left tips put on the ears, central pads (nose pads) or the like.

In the pair of eyeglasses of the present embodiments, focal length can be adjusted by sliding a figure while touching on the touch sensor 33.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An eyeglasses apparatus comprising:
first and second liquid crystal lenses, wherein the first liquid crystal lens comprises a first liquid crystal layer and a plurality of first control electrodes on the first liquid crystal layer;
a pair of temples;
a sensor which is provided on one of the pair of temples, comprising a longitudinal direction and configured to detect a contact position on a detector plane; and
a driver configured to apply a plurality of voltage to the plurality of the first control electrodes, wherein a focal length of the first liquid crystal lens is determined according to an amount of movement of the contact position when the contact position continuously moves along the longitudinal direction, and each voltage value is determined according to the focal length of the first liquid crystal lens.

2. The pair of eyeglasses apparatus of claim 1, wherein the focal length of the first liquid crystal lens is determined according to the direction of movement of the contact position.

3. The pair of eyeglasses apparatus of claim 1, wherein the first liquid crystal lens further comprises a concave lens or a convex lens.

4. The pair of eyeglasses apparatus of claim 1, further comprising a controller configured to determine the focal length of the first liquid crystal lens according to the amount of the movement of the contact position.

5. The pair of eyeglasses apparatus of claim 4, wherein the controller is configured to transmit information corresponding to the focal length by a wireless signal to the driver.

6. The pair of eyeglasses apparatus of claim 1, further comprising a memory unit which stores a table in which voltage optimal to each electrode with respect to the focal length is written.

7. The pair of eyeglasses apparatus of claim 1, further comprising a detector configured to detect whether the pair of eyeglasses apparatus is being worn on the body or not, wherein the sensor and the driver are operated when the detector detects that the pair of eyeglasses apparatus is being worn on the body.
